(19) United States
(12) Patent Application Publication
(10) Pub. No.: US 2014/0365698 A1
(43) Pub. Date: Dec. 11, 2014

(54) EXPANSION OF PCI-E COMPATIBLE CHASSIS

(71) Applicant: AGILENT TECHNOLOGIES, INC., Loveland, CO (US)

(72) Inventors: Jared RICHARD, Fort Collins, CO (US); Kuen Yew LAM, Loveland, CO (US); Chris R. JACOBSON, Fort Collins, CO (US); James BENSON, Loveland, CO (US)

(21) Appl. No.: 13/910,743

(22) Filed: Jun. 5, 2013

(51) Int. Cl. G06F 13/40

(52) U.S. Cl. CPC G06F 13/4022; G06F 13/4068
USPC 710/300; 710/316

(57) ABSTRACT

A chassis comprises a backplane comprising a switch fabric compatible with peripheral component interconnect express (PCI-E) and configured to support communication between a plurality of module slots, a module slot compatible with PCI-E and disposed on the backplane, a cavity disposed adjacent to the module slot and having a width greater than or equal to a width of the module slot and a height greater than or equal to a height of the module slot, and a device connection interface located in the cavity and configured to support connection of at least one PCI-E compatible module to the switch fabric via the module slot.

### BACKGROUND

Peripheral component interconnect express (PCI-E) is a standard for incorporating peripheral devices in computing systems and other electronic apparatuses. The standard defines interfaces and protocols for communication with PCI-E compatible devices and is commonly used in consumer and industrial applications as a motherboard level interconnect, a backplane interconnect, and an expansion card interface.

PCI-E has also been adapted for various modular applications, such as external chassis used to connect numerous peripheral devices to a host system. These modular applications have achieved popularity because they provide system integrators with flexibility to connect various peripheral devices according to their specific needs.

In an effort to standardize certain aspects of modular PCI-E applications, committees have developed compact PCI express (cPCI-E), which is a ruggedized version of PCI-E that can be used to incorporate peripherals in an external chassis, and PCI-E eXtensions for instrumentation (PXI-E), which is a version of cPCI-E adapted for test and measurement equipment such as oscilloscopes, logic analyzers, and so on.

A cPCI-E or PXI-E chassis typically comprises a system slot configured to receive a system control module, a plurality of peripheral slots each configured to receive a peripheral module, and a PCI-E switch fabric connected between the system slot and the peripheral slots. The chassis can be implemented in a standalone configuration where the system control module comprises an embedded controller such as a personal computer (PC) chipset, or it can be implemented in a hosted configuration where the system control module is connected to a remote host via a PCI-E cabled interface. A cPCI-E or PXI-E chassis can also be expanded through the use of cabled PCI-E modules, which can be inserted into the slots of the chassis and connected to additional downstream chassis or modules. For example, a cabled PCI-E module can be used to connect a first chassis to a second downstream chassis in a daisy chained configuration.

A significant shortcoming of conventional PCI-E compatible chassis is that their design may often result in underutilization of resources. As an example, most cPCI-E and PXI-E chassis have space for two-slot or four-slot wide modules to accommodate the large design of embedded controllers, even though only one slot is required for the more common configuration with a system control module connected to a remote host via a cabled target adapter. Consequently, unless the chassis is connected to an embedded controller, some of the space may go unused. As another example, most cPCI-E or PXI-E chassis provide a relatively high amount of power and cooling capability to support embedded controllers, even though most cabled target adapters do not use or require this capability. Consequently, unless the chassis is connected to an embedded controller, power and cooling capability may go unused.

In view of at least the above shortcomings of conventional PCI-E compatible chassis, there is a general need for new approaches to improve utilization of resources in the chassis.

### SUMMARY

In a representative embodiment, a chassis comprises a backplane comprising a switch fabric compatible with PCI-E and configured to support communication between a plurality of module slots, a module slot compatible with PCI-E and disposed on the backplane, a cavity disposed adjacent to the module slot and having a width greater than or equal to a width of the module slot and a height greater than or equal to a height of the module slot, and a device connection interface located in the cavity and configured to support connection of at least one PCI-E compatible module to the switch fabric via the module slot.

In certain embodiments, the module slot is a system slot configured to support connection of an embedded controller or a remote cabled controller to the switch fabric. Moreover, in certain embodiments, the cavity is located on a first side of the system slot, with the chassis further comprising a plurality of peripheral slots compatible with PCI-E and disposed on a second side of the system slot opposite the first side. p In certain embodiments, the chassis further comprises a cabled PCI-E interface module connected to the system slot and comprising a switch compatible with PCI-E and configured to connect the device connection interface to the system slot. The cabled PCI-E interface module can be, for instance, a cabled target adapter. The switch can be configured to support concurrent operation of the remote cabled controller connected to the system slot and at least one peripheral device connected to the device connection interface. The switch can communicate with the backplane via a plurality of PCI-E lanes and bridges a first subset of the lanes to at least one cable port of the cabled PCI-E interface and a bridges a second subset of the lanes to the device connection interface.

In certain embodiments, the device connection interface comprises a mezzanine card connected to the cabled PCI-E interface module via a mezzanine connector. The cabled PCI-E interface module can comprise, for instance, a first printed circuit board (PCB) and the mezzanine card comprises a second PCB arranged substantially perpendicular to the first PCB. The device connection interface can further comprise, for instance, at least one module slot disposed on the second PCB and configured to receive a PCI-E compatible module, and the at least one module slot can be configured to receive a PCI-E compatible module for input/output expansion of the chassis.

In certain embodiments, the cabled PCI-E interface module comprises a first PCB and the mezzanine card comprises a second PCB arranged substantially parallel to the first PCB. The device connection interface can comprise, for instance, a connector for a peripheral module and the connector is located on a side of the second PCB proximate the first PCB. The cavity can have a width approximately equal to a width of the module slot.

In certain embodiments, the chassis further comprises a power supply mounted on the second PCB and a power connector connected to the second PCB, The power supply can receive power, for instance, from the system slot via the cabled PCI-E interface module and the mezzanine connector or through a dedicated power cable. The power supply can be located, for instance, on a side of the second PCB opposite the first PCB.

In certain embodiments, the chassis is a cPCI-E chassis or a PXI-E chassis. In certain embodiments, the chassis further comprises a cooling facility configured to generate airflow across the cavity.

### BRIEF DESCRIPTION OF THE DRAWINGS

The described embodiments are best understood from the following detailed description when read with the accompanying drawing figures. Wherever applicable and practical, like reference numerals refer to like elements.

FIG. 1 is a diagram illustrating a PXI-E chassis in accordance with a representative embodiment.

FIG. 2 is a diagram illustrating various components of a PXI-E chassis in accordance with a representative embodiment.

FIG. 3 is a diagram illustrating a PXI-E chassis connected to a cabled target adapter and a cabled host adapter in accordance with a representative embodiment.

FIG. 4 is a diagram illustrating a cabled target adapter in accordance with a representative embodiment. p FIG. 5 is a diagram illustrating an example of communication between various components of the cabled target adapter of FIG. 4 in accordance with a representative embodiment.

FIG. 6 is a diagram illustrating another example of communication between various components of the cabled target adapter of FIG. 4 in accordance with a representative embodiment.

FIG. 7 is a diagram illustrating an example configuration of a mezzanine card in relation to the cabled target adapter of FIG. 4 in accordance with a representative embodiment.

FIG. 8 is a diagram illustrating another example configuration of a mezzanine card in relation to the cabled target adapter of FIG. 4 in accordance with a representative embodiment.

FIG. 9 is a diagram illustrating another example configuration of a mezzanine card in relation to the cabled target adapter of FIG. 4 in accordance with a representative embodiment.

### DETAILED DESCRIPTION

In the following detailed description, for purposes of explanation and not limitation, representative embodiments disclosing specific details are set forth in order to provide a thorough understanding of the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the example embodiments. Such methods and apparatuses are clearly within the scope of the present teachings.

The terminology used herein is for purposes of describing particular embodiments only, and is not intended to be limiting. The defined terms are in addition to the technical and scientific meanings of the defined terms as commonly understood and accepted in the technical field of the present teachings. As used in the specification and appended claims, the terms ‘a’, ‘an’ and ‘the’ include both singular and plural referents, unless the context clearly dictates otherwise. Thus, for example, ‘a device’ includes one device and plural devices.

The described embodiments relate generally to modular PCI-E based systems such as CPCI-E and PXI-E chassis. Examples of such systems, including example operational details, are described in U.S. patent application Ser. No. 13/191,892 filed Jul. 27, 2011 by Richard, U.S. patent application Ser. No. 13/245,176 filed Sep. 26, 2011 by Richard, and U.S. patent application Ser. No. 13/247,482 filed Sep. 28, 2011 by Richard. The respective disclosures of these patent applications are specifically incorporated herein by reference. It is emphasized that the features described in these patents and patent applications are representative in nature, and alternatives within the purview of one of ordinary skill in the art are contemplated.

In certain embodiments described herein, a PCI-E compatible chassis, such as a CPCI-E or PXI-E chassis, comprises a backplane comprising a switch fabric compatible with PCI-E and configured to support communication between a plurality of module slots, a module slot compatible with PCI-E and disposed on the backplane, a cavity disposed adjacent to the module slot and having a width greater than or equal to a width of the module slot and a height greater than or equal to a height of the module slot, and a device connection interface located in the cavity and configured to support connection of at least one PCI-E compatible device to the switch fabric via the module slot. The presence of the device connection interface in the cavity allows a user to include corresponding peripheral devices within the cavity. These peripheral devices can take advantage of cooling capability provided in the cavity under the CPCI-E or PXI-E standard, and also power supply capability provided by the system slot under the CPCI-E or PXI-E standard.

The device connection interface is connected to the backplane through the system slot via an intervening connection structure. The intervening connection structure can comprise, for instance, a cabled target adapter connected to a mezzanine card, with at least one device connection interface comprising one or more slots disposed on the mezzanine card. In such embodiments, the cabled target adapter may comprise a switch configured to bridge several PCI-E lanes from the system slot to the mezzanine card. This mezzanine card can support connection of a variety of peripheral devices to the device connection interface using space and cooling capability provided by the cavity and power provided through the system slot. As an alternative to the mezzanine card, the intervening connection structure could comprise, for instance, an additional backplane, with the at least one device connection interface comprising one or more slots disposed on the additional backplane.

In some embodiments, at least one device connection interface can be used to facilitate various “infrastructure functions”, such as PCI-E based cards for I/O expansion, PCI-E based cards for acceleration, or a power supply. One potential benefit of facilitating such infrastructure functions is that it may prevent a user of the chassis from occupying the peripheral slots for these infrastructure functions, saving those slots for more specialized uses, such as instrumentation specific modules.

In the description that follows, various embodiments are described with reference to a PXI-E chassis. However, the described concepts could be adapted to another type of PCI-E compatible chassis such as a CPCI-E chassis or PCI-E based expander chassis.

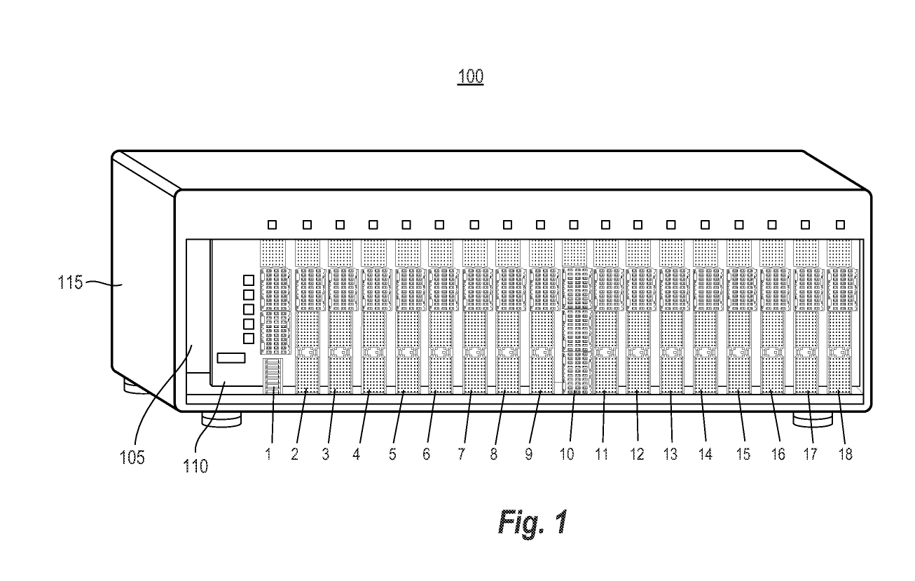

FIG. 1 is a diagram illustrating a PXI-E chassis 100 in accordance with a representative embodiment. PXI-E chassis 100 is one example of a PCI-E compatible chassis that could be used with various embodiments,

Referring to FIG. 1, PXI-E chassis 100 comprises a physical support structure 115, a plurality of module slots 1 through 18 configured to receive various PCI-E compatible modules, a cavity 105 configured to house and cool an embedded controller, and a backplane 110 located at the back of cavity 105 and behind module slots 1 through 18, Among module slots 1 through 18, slot 1 is a system slot, slot 10 is a timing slot, and slots plurality of peripheral slots 2 through 18.

System slot 1 is designated to receive a system control module for controlling modules in each of the other slots. In general, the system control module can be an embedded controller or a cabled PCI-E interface module, such as a cabled target module or host module. In several embodiments described below, it is assumed that system slot 1 is occupied by a cabled target module connected to a remote host such as a PC. System slot 1 comprises a connector for power, another two connectors for PCI-E, and an instrument specific connector. Unlike other slots, system slot 1 typically has the capability to provide about 140 watts of power and cooling through its dedicated power connector not present in other slots.

Timing slot 10 is designated to receive a timing module for generating timing and synchronization signals for the other slots. It comprises a connector for providing timing signals as well as connectivity as a PXI-E peripheral slot. The remaining slots are designated to receive peripheral modules or cabled PCI-E interface modules, such as host modules or target modules, Peripheral slots 2-9 and 11-18 are all hybrid slots, with each one comprising a 32-bit PCI connector, a PCI-E connector, and a connector for instrument functions such as triggers and clocks. Timing slot 10 has special connectors dedicated to timing and synchronization functionality but can operate as a peripheral slot whether these resources are used or not.

Backplane 110 provides physical and logical support for module slots 1 through 18. For instance, module slots 1 through 18 are physically mounted on backplane 110, a portion of which is shown in FIG. 1. Modules connected to module slots 1 through 18 can communicate with each other through a switch fabric, which is typically disposed on backplane 110, although it truly alternatively be located, at least in part, on a mezzanine card connected to backplane 110.

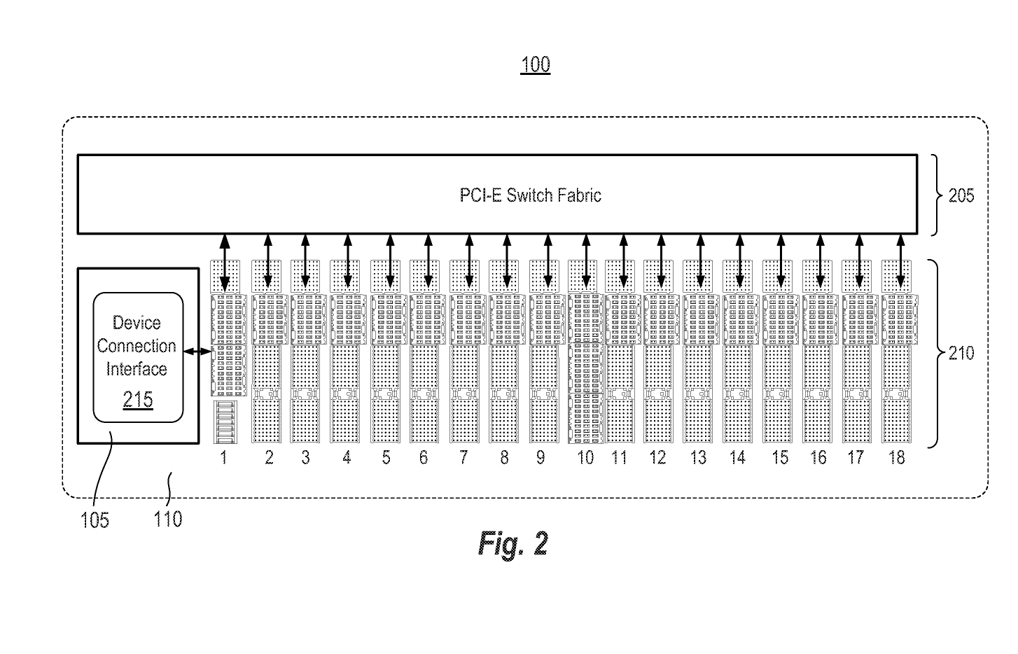

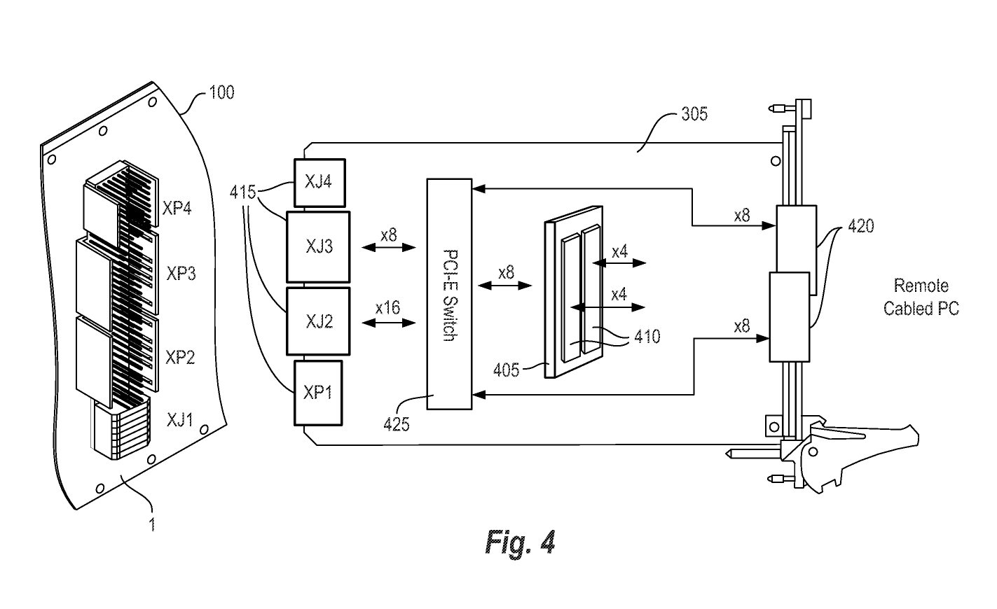

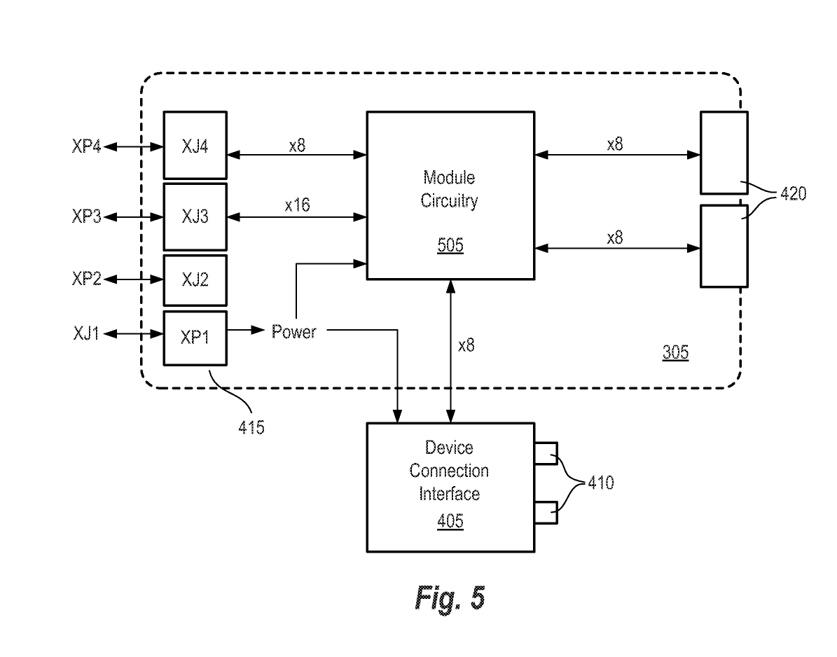

Cavity 105 is located to the left of system slot 1 and has a size designed to accommodate an embedded controller connected to system slot 1. For instance, cavity 105 typically has a width large enough to accommodate a two-slot wide or four-slot wide embedded controller. In addition, cavity 105 typically has cooling facilities, such as a vertical airflow, configured to provide supplemental cooling for the embedded controller. For instance, cavity 105 may provide enough cooling for an embedded controller generating up to 140 watts of heat, while other slots may provide only 30 watts of cooling.

Where system slot 1 is not occupied by an embedded controller (e.g., where it is occupied by a cabled target adapter), the space and cooling capacity provided by cavity 105, as well as the power provided by system slot 1, can potentially be used to support additional peripheral modules in chassis 100. To this end, cavity 105 can be occupied by at least one device connection interface for connecting the additional devices, e.g., PCI-E devices or infrastructure devices. As an example, FIG. 4 illustrates two device connection interfaces implemented on a mezzanine card connected to a cabled target adapter. The additional modules may be, for instance, but not limited to, input/output (I/O) devices, data storage devices, or hardware acceleration devices. Various examples of such device connection interfaces, peripheral modules, and related implementation details are described below in relation to FIGS. 2 through 9.

One potential benefit of allowing additional peripheral modules in cavity 105 is that it may prevent users from unnecessarily occupying instrumentation slots with non-instrumentation modules. For instance, a user may be able to achieve basic I/O expansion of a chassis (e.g., by a LAN device, a USB device, etc.) without using one of slots 2 through 18, which are generally designed for the more specialized purpose of accommodating instrumentation modules.

Another potential benefit of allowing additional peripheral devices in cavity 105 is that it may facilitate hardware acceleration for other functions performed by chassis 100. For instance, a peripheral module in cavity 105 may be connected, in a peer-to-peer fashion via the PCI-E switch fabric, to an instrumentation module in one of slots 2 through 18. Using this peer-to-peer connection, the peripheral module in cavity 105 may perform functions such as those of a digital signal processor (DSP), graphics processing unit (GPU), or a physics processing unit (PPU), for instance, without requiring the relevant data to leave chassis 100. Similarly, the peripheral module may be a storage component such as a solid state drive (SSD) or hard disk drive (HDD), which may be accessed by other modules through direct memory access (DMA) requests. Using cavity 105 space to enhance the chassis peer-to-peer data movement may provide the benefit of towering the load on the upstream cable connection to the host CPU (thus further enhancing overall system performance) in addition to enhancing the performance of peer-to-peer operation itself by architecting for locality of data movement.

Yet another potential benefit is that the additional peripheral modules in cavity 105 may take advantage of the additional power and cooling capability to provide power for various devices that may be used in connection with chassis 100. For instance, a peripheral module in cavity 105 may be used to implement a power supply for a device under test (DUT), a fixture, a radio frequency (RF) switch, or RF load. As an option in implementing this, cavity 105 hardware may be provided with additional power and/or data connectors provided on the backplane board 715 in addition to those already provided for slot 1.

FIG. 2 is a diagram illustrating various components of PXI-E chassis 100 in accordance with a representative embodiment.

Referring to FIG. 2, PXI-E chassis 1100 comprises module slots 1 through 18, cavity 105, and backplane 110, as described above in relation to FIG. 1. For simplicity, module slots 1 through 18 have been collectively labeled as module slots 210. PXI-E chassis 100 further comprises a PCI-E switch fabric 205 disposed on backplane 110, and a device connection interface 215 located within cavity 105.

Switch fabric 205 is used to transfer signals between different parts of PXI-E chassis 100. In certain embodiments, switch fabric 205 comprises PCI-E switches that can be reconfigured using one or more switch images stored in a memory device such as an electrically erasable programmable read only memory (EEPROM). These switch images are typically loaded into switch fabric 205 upon powering up or resetting chassis 100, and they define certain characteristics of PXI-E chassis 100, such as a number of links for communicating between slot 1 and the peripheral slots, and whether a certain slot should be designated to receive a cabled target adapter or cabled host adapter. The switch image(s) can be selected by a user from among multiple stored images. For example, a user wishing to designate a peripheral slot as a downstream target slot my select a switch image that allows it to receive a target module. Additionally, to support the operation of device connection interface 215 and related peripheral devices, system slot 1 may be reconfigured to create links to those components.

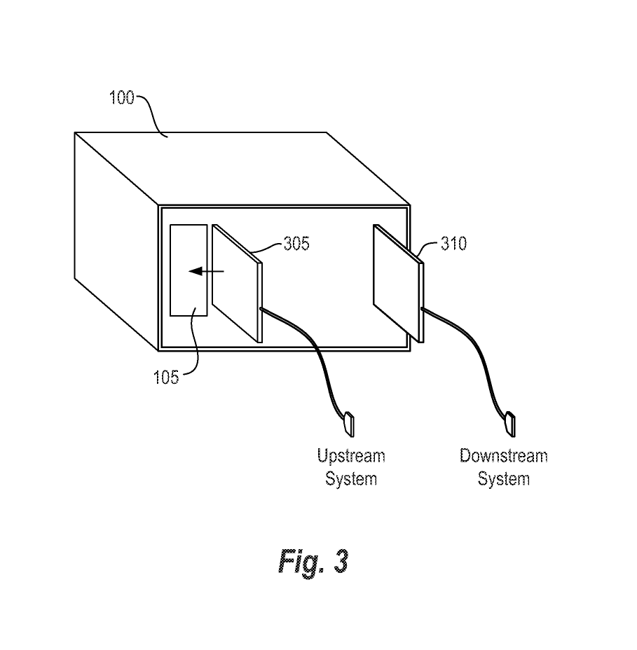

FIG. 3 is a diagram illustrating a connection of a cabled target adapter 305 and cabled host adapter 310 to PXI-E chassis 100 in accordance with a representative embodiment. This diagram illustrates how cabled PCI-E interface modules can connect PXI-E chassis 100 with other system components. It is also illustrates how a cabled PCI-E interface module can be expanded to include a device connection interface for connecting modules within cavity 105.

Referring to FIG. 3, cabled target adapter 305 is connected to system slot 1 of chassis 100 and is connected to an upstream host such as a remote PC. It operates under the control of the upstream host to control other components of PXI-E chassis 100, such as peripheral modules in peripheral slots 2-9 and 11-18. Cabled host adapter 310, on the other hand, is a host module located in one of peripheral slots 2-9 and 11-18. It is controlled by cabled target adapter 305 and is connected to a downstream device or system, such as a cascaded chassis or RAID.

In an alternative implementation, cabled target adapter 305 can be reconfigured to operate as a host module, or cabled host adapter 310 can be reconfigured to operate as a target module. This can be accomplished, for example, by toggling a switch on either of these modules to change their respective directions of operation, as described, for instance, in U.S. patent application Ser. No. 13/247,482. Where cabled target adapter 305 is reconfigured to operate as a host module, it can be connected to a downstream system rather than an upstream system as shown in FIG. 3. Similarly, where cabled host adapter 310 is reconfigured to operate as a host module, it can be connected to an upstream system rather than a downstream system as shown in FIG. 3. In yet another setup, both a host and target connection can be set up on a single module through two separate connectors.

Cabled target adapter 305 can be expanded to include a device connection interface on its left side, as indicated by an arrow pointing to the left. This expansion to the left may allow additional modules to be connected within cavity 105. Various examples of such expansion are described below with reference to FIGS. 4 through 9.

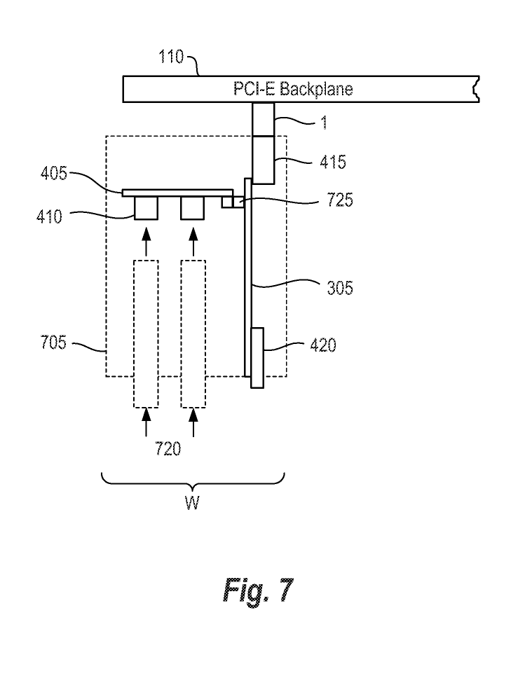

FIG. 4 is a diagram illustrating an example of cabled target adapter 305 in accordance with a representative embodiment. This diagram illustrates one possible way of attaching a device connection interface to cabled target adapter 305, and various alternative configurations are shown in FIGS. 7 through 9. In addition, other types of device connection interfaces not shown in the drawings could be used in conjunction with cabled target adapter 305, such as cabled interfaces.

Referring to FIG. 4, cabled target adapter 305 comprises a PCB having a plurality of connectors 415 at one end and a plurality of cable ports 420 at another end. Connectors 415 are designed to for connecting cabled target adapter 305 to chassis 100, and cable ports 420 are designed for connecting cabled target adapter 305 to a cable leading to an upstream device. In this example, it is assumed that connectors 415 are designed for connection to system slot 1 of chassis 100. These connectors comprise an XJ3 connector and an XJ2 connector for communicating PCI-E signals, and an XP1 connector for power, and an XJ4 connector for instrument specific functions. The pin assignments of each of these connectors are determined by the cPCI-E and PXI-E specification. System slot 1 comprises an XP4 connector for connection to the XJ4 connector, an XP3 connector for connection to the XJ3 connector, an XP2 connector for connection to the XJ2 connector, and an XJ1 connector for connection to the XP3 connector.

Cabled target adapter 305 further comprises a device connection interface 405 comprising connectors 410. Device connection interface 405 comprises a mezzanine card connected to the PCB of cabled target adapter 305 using a mezzanine connector. Connectors 410 are typically designed to receive peripheral modules, such as storage modules or hardware acceleration modules. For instance, connectors 410 could each be configured to receive an SSD, a DSP, or a GPU.

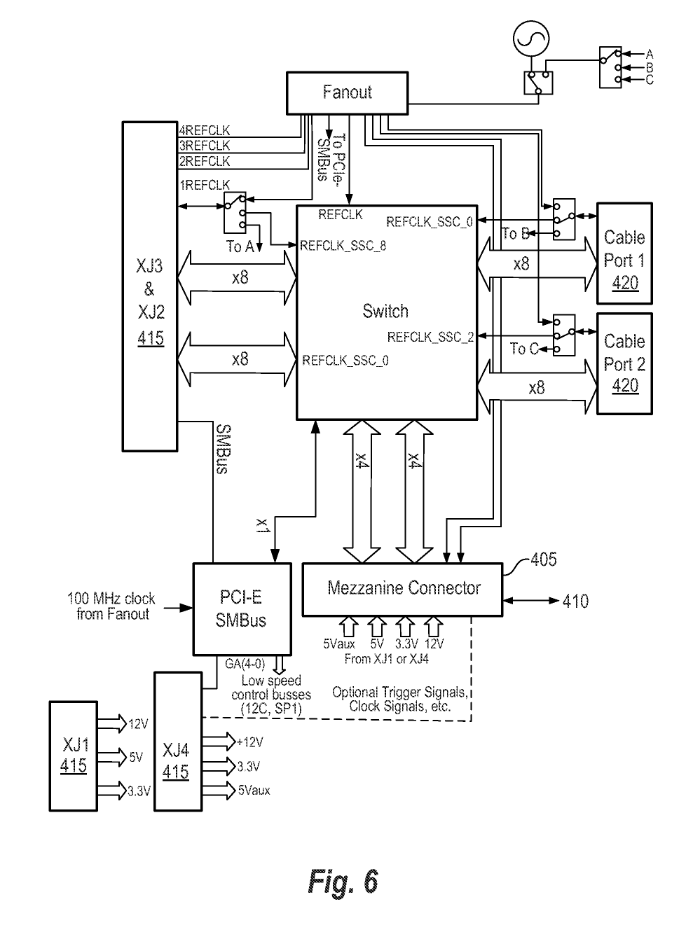

Cabled target adapter 305 still further comprises a PCI-E switch 425 configured to control communication between connectors 415, cable ports 420, and device connection interface 405. As illustrated by arrows labeled “x8” and “x16”, connectors 415 provide an 8 lane communication link and a 16 lane communication link between cabled target adapter 305 and chassis 100. As illustrated by three additional arrows labeled “x8”, the 8 and 16 lane links are used to form 8 lanes of communication (e.g., two 4 lane links) between connectors 410 of device connection interface 405 and chassis 100 through cable(target adapter 305, and two 8 lane links between cable ports 420 and chassis 100. These links are managed by PCI-E switch 425, which is typically a transparent switch with enough lanes to enable connectivity to backplane 110, cable ports 420, a system management bus (SMBus), and the mezzanine connector. An additional example of such a switch is illustrated in FIG. 6. In alternative embodiments, the number of lanes and their respective configurations can be changed.

FIG. 5 is a diagram illustrating an example of communication between various components of cabled target adapter 305 of FIG. 4 in accordance with a representative embodiment.

Referring to FIG. 5, cabled target adapter 305 comprises connectors 415, cable ports 420, and device connection interface 405, as described with reference to FIG. 4. It further comprises module circuitry 505, which communicates with the other features as shown in FIG. 5. Module circuitry 505 may comprise, for instance, a PCI-E switch, a PCI-E SMBus, circuitry for generating control signals, and so on.

Among connectors 415, the XJ3 and XJ2 connectors provide 24 lanes of communication between chassis 100 and module circuitry 505. The PCI-E switch bridges eight of the lanes to device connection interface 405, and it bridges eight more of the lanes to each of cable ports 420. Meanwhile, the XP1 connector provides power directly to device connection interface 405 and module circuitry 505 through the mezzanine connector or cable assembly.

FIG. 6 is a diagram illustrating another example of communication between various components of cabled target adapter 305 of FIG. 4 in accordance with a representative embodiment.

Referring to FIG. 6, this example is similar to that illustrated in FIG. 5, except that more specific implementation details are shown in place of module circuitry 505. For instance, the transfer of signals between various connectors is facilitated by various switching components and control signals as shown in the figures. In this example, a switch offers two bi-directional cabled interfaces (See, e.g., U.S. patent application Ser. No. 13/247,482), two to four links of connectivity to backplane 110, a single link to the SMBus (shared in this example), and two four lane links for device connection interface 405.

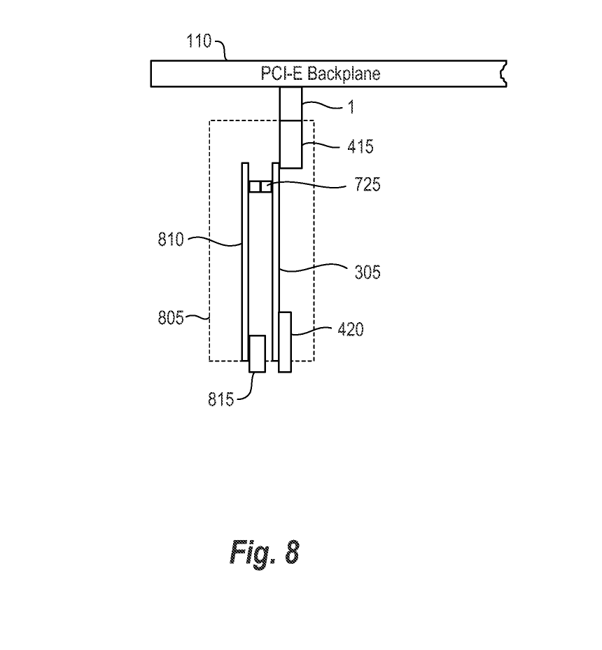

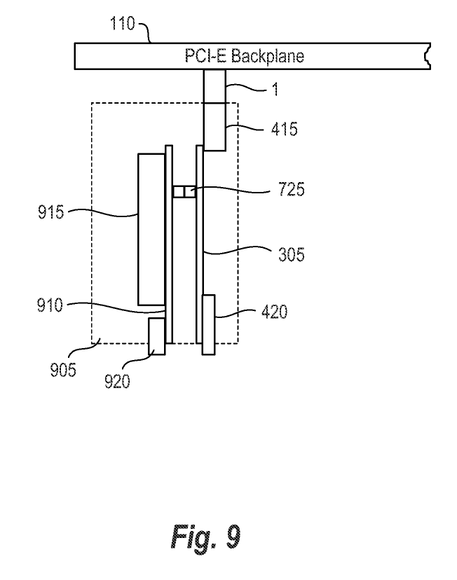

FIG. 7 is a diagram illustrating an example configuration of a mezzanine card in relation to cabled target adapter 305 of FIG. 4 in accordance with a representative embodiment. This diagram, as well as those of FIGS. 8 and 9, are shown from a top view of chassis 100. In the example of FIG. 7, a module 705 is formed by the combination of cabled target adapter 305 and the mezzanine card. This module is designed to be accommodated, at least in part, within cavity 105 as shown in FIG, 2.

Referring to FIG. 7, module 705 comprises cabled target adapter 305, device connection interface 405, connectors 410, connectors 415, cable ports 420, and a mezzanine connector 725 connected between cabled target adapter 305 and device connection interface 405. Device connection interface 405 comprises a PCB arranged substantially perpendicular to a PCB of cabled target adapter 305. Connectors 415 are connected to system slot 1, and module 705 communicates with backplane 110 through this connection. Connectors 410 can be configured to receive various types of device modules 720 as indicated above, such as a storage device or an acceleration device. As a specific example, one or more of device modules 720 could be a 2.5 inch PCI-E SSD or a mobile graphics processing card. Device modules 720 can communicate with backplane 110 via mezzanine connector 725 and connectors 415 through appropriate logic on cabled target adapter 305.

As illustrated by a brace at the bottom of FIG. 7, module 705 has a width “w”, which is established according to the width of cavity 105. As indicated above, cavity 105 is typically designed with a width sufficient to accommodate a two-slot or four-slot wide module in system shot 1. Accordingly, module 705 may be designed according to this width constraint.

FIG. 8 is a diagram illustrating another example configuration of a mezzanine card in relation to the cabled target adapter 305 of FIG. 4 in accordance with a representative embodiment. In the example of FIG. 8, a module 805 is formed by the combination of cabled target adapter 305 and the mezzanine card. This module is designed to be accommodated, at least in part, within cavity 105 as shown in FIG. 2.

Referring to FIG. 8, module 805 comprises cabled target adapter 305, device connection interface 810, a connector 815, cable ports 420, and a mezzanine connector 725 connected between cabled target adapter 305 and device connection interface 810. Device connection interface 810 comprises a PCB arranged substantially parallel to a PCB of cabled target adapter 305. Connectors 415 are connected to system slot and module 805 communicates with backplane 110 through this connection. Connector 815 and the corresponding board can be configured to receive various types of device modules for implementing infrastructure functions, for instance. Examples of such modules include LAN or USB modules or Thunderbolt. These modules can communicate with backplane 110 via mezzanine connector 725 and connectors 415.

FIG. 9 is a diagram illustrating another example configuration of a mezzanine card in relation to the cabled host adapter of FIG. 4 in accordance with a representative embodiment. In the example of FIG. 9, a module 905 is formed by the combination of cabled target adapter 305 and the mezzanine card. This module is designed to be accommodated, at least in part, within cavity 105 as shown in FIG. 2.

Referring to FIG. 9, module 905 comprises cabled target adapter 305, device connection interface 910, a power supply 915, a power connector 920, cable ports 420, and a mezzanine connector 725 connected between cabled target adapter 305 and device connection interface 910. Device connection interface 910 comprises a PCB arranged substantially parallel to a PCB of cabled target adapter 305. Connectors 415 are connected to system slot 1, and module 905 communicates with backplane 110 through this connection. Power connector 920 is configured to supply power from power supply 915 to a cable connected device. Power supply 915 receives power from system slot 1, which is designed to have enough power output to operate an embedded controller. By providing module 905, this power can be used, for instance, to operate devices used in conjunction with chassis 100, such as a DUT.

While representative embodiments are disclosed herein, one of ordinary skill in the art appreciates that many variations that are in accordance with the present teachings are possible and remain within the scope of the appended claim set. The invention therefore is not to be restricted except within the scope of the appended claims.

1. A chassis, comprising:
a backplane comprising a switch fabric compatible with peripheral component interconnect express (PCI-E) and configured to support communication between a plurality of module slots;
a module slot compatible with PCI-E and disposed on the backplane;
a cavity disposed adjacent to the module slot and having a width greater than or equal to a width of the module slot and a height greater than or equal to a height of the module slot; and
a device connection interface located in the cavity and configured to support connection of at least one PCI-E compatible module to the switch fabric via the module slot.

2. The chassis of claim 1, wherein the module slot is a system slot configured to support connection of an embedded controller or a remote cabled controller to the switch fabric.

3. The chassis of claim 2, wherein the cavity is located on a first side of the system slot, and the chassis further comprises a plurality of peripheral slots compatible with PCI-E and disposed on a second side of the system slot opposite the first side.

4. The chassis of claim 2, further comprising a cabled PCI-E interface module connected to the system slot and comprising a switch compatible with PCI-E and configured to connect the device connection interface to the system slot.

5. The chassis of claim 4, wherein the cabled PCI-E interface module comprises a cabled target adapter.

6. The chassis of claim 4, wherein the switch is configured to support concurrent operation of the remote cabled controller connected to the system slot and at least one peripheral device connected to the device connection interface.

7. The chassis of claim 4, wherein the switch communicates with the backplane via a plurality of PCI-E lanes and bridges a first subset of the lanes to at least one cable port of the cabled PCI-E interface and bridges a second subset of the lanes to the device connection interface.

8. The chassis of claim 4, wherein the device connection interface comprises a mezzanine card connected to the cabled PCI-E interface module via a mezzanine connector.

9. The chassis of claim 8, wherein the cabled PCI-E interface module comprises a first printed circuit board (PCB) and the mezzanine card comprises a second PCB arranged substantially perpendicular to the first PCB.

10. The chassis of claim 9, wherein the device connection interface further comprises at least one module slot disposed on the second PCB and configured to receive a PCI-E compatible module.

11. The chassis of claim 10, wherein the at least one module slot is configured to receive a PCI-E compatible module for input/output expansion of the chassis.

12. The chassis of claim 8, wherein the cabled PCI-E interface module comprises a first printed circuit board (PCB) and the mezzanine card comprises a second PCB arranged substantially parallel to the first PCB.

13. The chassis of claim 12, wherein the device connection interface comprises a connector for a peripheral module and the connector is located on a side of the second PCB proximate the first PCB.

14. The chassis of claim 12, wherein the cavity has a width approximately equal to a width of the module slot.

15. The chassis of claim 12, further comprising a power supply mounted on the second PCB and a power connector connected to the second PCB.

16. The chassis of claim 15, wherein the power supply receives power from the system slot via the cabled PCI-E interface module and the mezzanine connector or through a dedicated power cable or connector.

17. The chassis of claim 15, wherein the power supply is located on a side of the second PCB opposite the first PCB.

18. The chassis of claim 1, wherein the chassis is a compact PCI express (cPCI-E) chassis.

19. The chassis of claim 1, wherein the chassis is a PCI-E eXtensions for instrumentation (PXI-E) chassis.

20. The chassis of claim 1, further comprising a cooling facility configured to generate airflow across the cavity.
